(19) United States
(12) Patent Application Publication
(10) Pub. No.: US 2013/0114152 A1
(43) Pub. Date: May 9, 2013

(54) DAMPER WITH A PLURALITY OF SQUEEZE-FILM DAMPERS ACTING IN PARALLEL

(71) Applicant: Lorri Watson, Campbell, CA (US)

(72) Inventor: Douglas C. Watson, Cambell, CA (US)

(73) Assignee: NIKON CORPORATION, TOKYO (JP)

(21) Appl. No.: 13/288,708

(22) Filed: Nov. 3, 2011

(51) Int. Cl. F16F 9/10; G02B 7/02

(52) U.S. Cl. 359/819; 188/322.5

(57) ABSTRACT

A damper having a plurality of fluidic squeeze-film dampers acting in parallel. The damper of the present invention includes a plurality of fluidic squeeze-film dampers, each including a gap filled with viscous fluid provided between first and second damping elements. Each of the plurality of fluidic squeeze dampers creates an individual damping effect, which in the aggregate, act in parallel. As a result, the damper achieves (i) very high damping and stiffness over a relatively short stroke, (ii) compact size and (iii) adjustability to a limited degree by adjusting the gaps.

### BACKGROUND

1. Field of the Invention

This invention relates to dampers, and more particularly, to a damper with a plurality of squeeze-film dampers acting in parallel.

2. Description of Related Art

Photolithography is a well-known technique for fabricating patterns onto substrates, such as semiconductor wafers or LCD panels. Photolithography tools typically include a light source, a substrate stage for holding a substrate to be pattered, a projection lens system, and a reticle stage, which holds a reticle defining the pattern to be projected onto the substrate. During operation, a substrate covered with a light-sensitive material, such as photoresist, is placed on the substrate table. The projection lens system then projects light from the light source through the reticle onto the substrate, resulting in the pattern being formed on the light-sensitive material. In a series of subsequent chemical and/or etching steps, the pattern defined by the reticle is formed on the substrate under the pattern photoresist. By repeating the above process multiple times, the complex circuitry of semiconductor wafer, or the pixels of an LCD display panel, may be created on the substrate.

The lenses of the projection lens system are typically mounted within a lens barrel, which is a tube-like structure with an outer wall and an inner wall. Ideally, the lenses and the two walls of the lens barrel maintain the same relative position with respect to one another. In the event of vibration or other disturbances, the lenses preferably move in unison, thereby maintaining alignment with respect to one another. Maintaining the relative position of the lenses, however, is often challenging for a number of reasons. Some of the lenses within the barrel may be adjustable for focus, distortion control, temperature compensation, etc. In addition, the lens barrel may be subject to shaking and/or vibrations caused by the movement of stages or other disturbances. Both these factors make maintaining relative alignment difficult.

The use of actuators and other linkages is one known way to mount the lenses within the lens barrel. In general, the stiffer the actuators and linkages, the better for maintaining lens position and alignment.

US Patent Publication 2008/0285161 describes a system including an actuator between an inner lens barrel and an out lens barrel positioned within a container, which is filled with a viscous fluid, such as an oil. The viscous fluid fills in the gap between the inner and outer lens barrels, which is small enough, to largely prevent displacement of the viscous fluid in the gap during relatively fast movements of the inner and outer lens barrels, resulting in increased stiffness between the two barrels.

US Patent Publication 2009/0180091 describes the use of various dampers in an actuator assembly used for mounting the lenses of a lithography tool within a lens barrel. Each of these dampers, however, have or defined only a single fluidic squeeze-film damper.

With the aforementioned dampers, it is difficult to achieve sufficient damping to damp vibration modes of the lenses because the mechanical stiffness of the actuators and other linkages is so high.

### SUMMARY OF THE INVENTION

A damper having a plurality of fluidic squeeze-film dampers acting in parallel solves the above-described problems with conventional dampers. The damper of the present invention includes a plurality of fluidic squeeze-film dampers, each including a gap filled with viscous fluid provided between first and second damping elements. Each of the plurality of fluidic squeeze-film dampers creates an individual damping effect, which act in parallel. As a result, the damper achieves (i) very high damping and stiffness over a relatively short stroke, (ii) compact size and (iii) adjustability to a limited degree by adjusting the gaps. Each of these advantages makes the damper ideally suited for use in a lens barrel of a lithography tool, where these benefits are desirable.

### BRIEF DESCRIPTION OF THE DRAWINGS

The invention may best be understood by reference to the following description taken in conjunction with the accompanying drawings, which illustrate specific embodiments of the invention.

FIGS. 1A through 1C are representative diagrams of a damper with multiple squeeze-film dampers acting in parallel in accordance with one non-exclusive embodiment the invention.

FIGS. 2A through 2C are various views of a damper with multiple squeeze-film dampers acting in parallel in accordance with another non-exclusive embodiment the invention.

FIGS. 3A and 3B are diagrams of additional dampers each with multiple squeeze-film dampers acting in parallel in accordance with additional non-exclusive embodiments the invention

FIGS. 4A and 4B are diagrams of an intermediate damper plate according to another embodiment of the invention.

FIG. 5 is a cross section diagram of the intermediate damper plates in use with an exemplary damper of the present invention.

FIG. 6 is a diagram illustrating an exemplary damper of the present invention between the inner and outer walls of a lens barrel is shown.

FIGS. 7A and 7B are diagrams illustrating a top down and perspective view of a lens mounted within a lens barrel using a damper of the present invention.

FIG. 8 is a diagram illustrating damping versus stroke using the damper of the invention.

FIGS. 9A and 9B are flow charts that outline a process for designing and making a substrate device.

It should be noted that like reference numbers refer to like elements in the figures.

### DETAILED DESCRIPTION OF SPECIFIC EMBODIMENTS

The invention will now be described in detail with reference to various embodiments thereof as illustrated in the accompanying drawings. In the following description, specific details are set forth in order to provide a thorough understanding of the invention. It will be apparent, however, to one skilled in the art, that the invention may be practiced without using some of the implementation details set forth herein. It should also be understood that well known operations have not been described in detail in order to not unnecessarily obscure the invention.

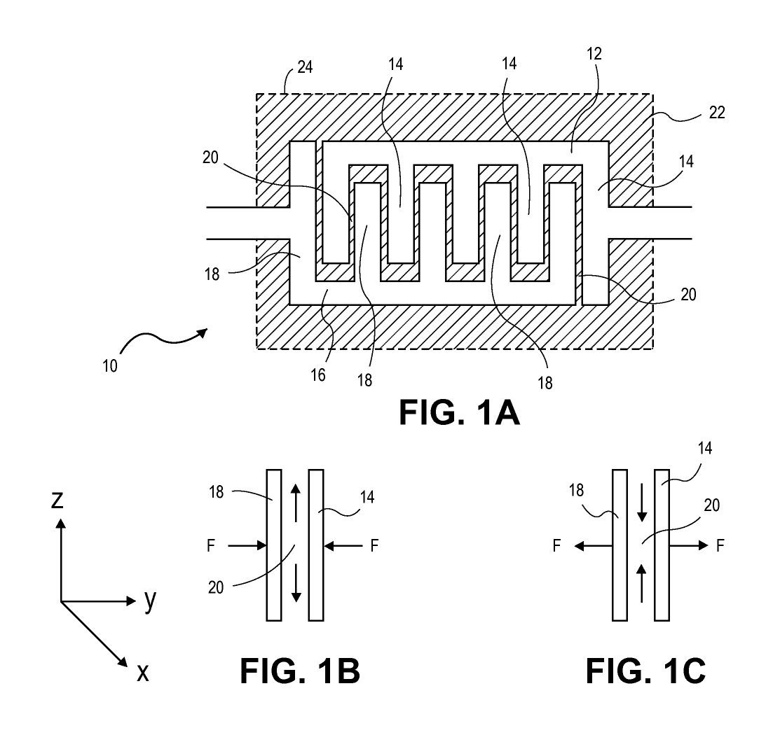

Referring to FIG. 1A, a diagram of a damper in accordance with one non-exclusive embodiment of the invention is shown. The damper 10 includes a first elongated damping member 12 including a plurality of first damping elements 14 and a second elongated damping member 16 including a second plurality of damping elements 18. The first and second elongated damping members 12 and 16 are arranged so that the first plurality of damping elements 14 and the second plurality of damping elements 18 are interleaved with respect to one another, forming a gap 20 between each pair. The first and the second elongated damping members 12 and 14 are also designed to allow differential motion with respect to one another. With differential motion, the width of the gap 20 between each interleaved pair of elongated damping members 14 and 18 varies. A viscous fluid 22 is provided around the first and the second elongated damping elements 12 and 16, filling each of the gaps 20. A container 24 is provided around the first and second elongated damping members 12 and 16 to contain the viscous fluid 22. In various embodiments, the viscous fluid may include glycerin, oil, alcohol, grease or any other viscous fluid.

With the above-described arrangement, a fluidic squeeze-film damper is created by each first and second damping element 14, 18 pair. As the first and second elongated damper members 12 and 16 move differentially relative to one another, the width of the gaps 20 between adjacent damping member 14, 18 pairs is altered. For example, if one gap 20 is widened, then the adjacent gaps 20 on either side will narrow.

As illustrated in FIG. 1B, an adjacent damping member pair 14, 18 is shown. When differential motion causes the pair 14, 18 to be forced together, as represented by the arrows F, the gap 20 is contracts. As a result, the viscous fluid 22 in a gap 20 is squeezed outward, as represented by the arrows in the gap 20.

As illustrated in FIG. 1C, on the other hand, shows adjacent damping members 14, 18 pulled apart from one another by differential movement, as designated by the force arrows F. As a result, the gap 20 expands and the viscous fluid 22 is pulled into the gap 20, as illustrated by the arrows in the gap.

The aggregate damping effect of each of the adjacent damping member 14, 18 pairs effectively act in parallel. The overall damping effect of the damper 10 results from summing the damping effect of each of the individual fluidic squeeze-film dampers. As the first and second damping members 12 and 16 move differentially with respect to one another, some gaps 20 expand, while the adjacent gaps 20 contract. Since some of the gaps are expanding while others are contracting, the overall damping constant of the damper 10 has less variation around the center position. The non-linearity dependency on gap width that is inherent with conventional squeeze-film dampers is therefore overcome.

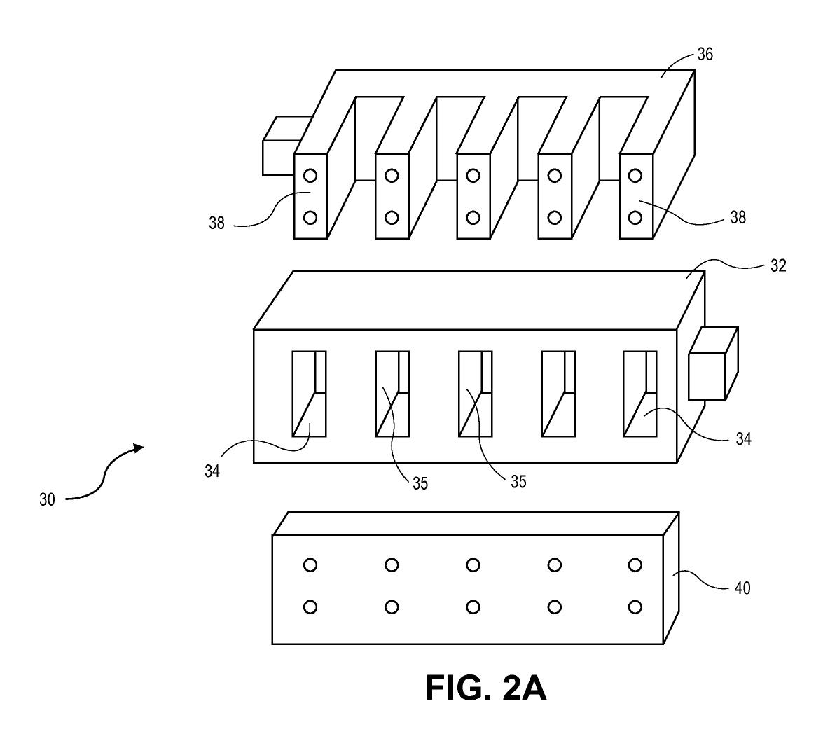

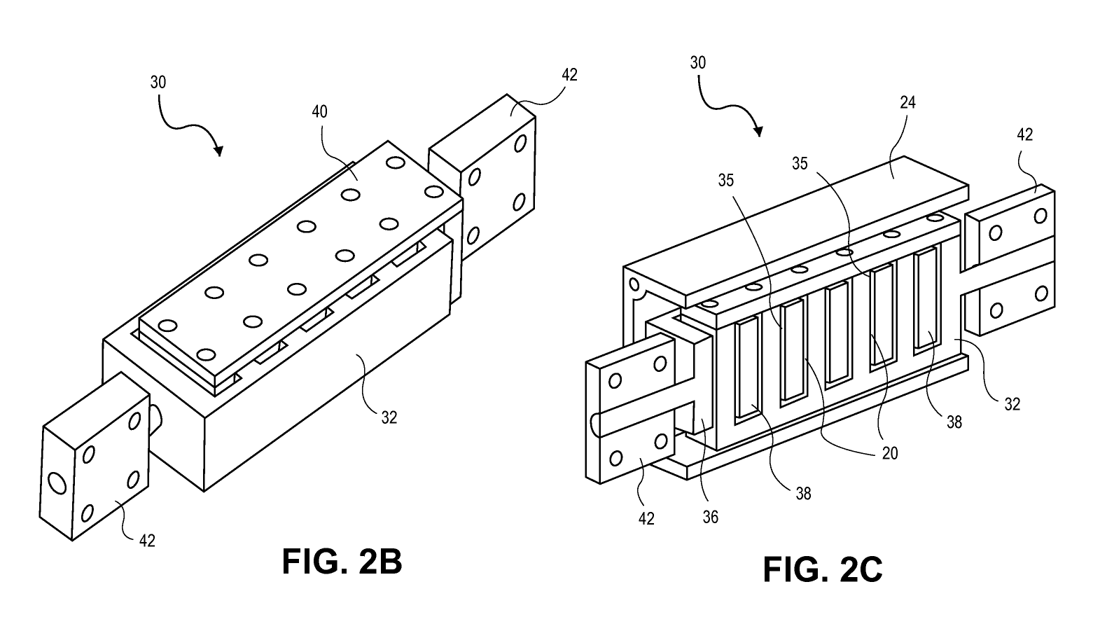

Referring to FIG. 2A, the components of a damper 30 in accordance with another embodiment is illustrated. The damper 30 includes a first elongated damping member 32 having a plurality of recess regions 34. The vertical interior sidewalls of each recess region 34 define a first plurality of damping elements 35. The damper 30 also includes a second elongated damping member 36 having a plurality of damping elements 38. When assembled, each of the damping elements 38 is inserted into the recess regions 34. With this arrangement, each damper element 38 is positioned adjacent the opposing damping elements 35 of each recess region 34. Although not visible in FIG. 2A, gaps 20 are provided between the plurality of damping elements 38 and the opposing damping element 35. A viscous fluid is provided in the gaps 20. As a result, a plurality of individual fluidic squeeze-film film dampers acting in parallel is provided. An assembly plate 40 constrains and supports the ends of the damping elements 38 on the second elongated damping member 36 when assembled.

FIG. 2B illustrates the damper 30 after assembly. First and second attachment elements 42 are provided on opposing ends of the damper 30. The attachment elements 42 are provided to attach the damper 30 between an inner lens barrel and an outer lens barrel for example.

FIG. 2C shows a cross section of the damper 30 after assembly and provided in a container 24. In this view, the gaps 20 are visible between each damping element pair 35 and 38, forming a pair of fluidic squeeze-film dampers formed on the opposing sides of each the damping elements 38. As the members 32 and 36 move differentially with respect to one another, the gap 20 on one side of each element 38 expands, while the gap 20 on the opposing side contracts. Accordingly in the aggregate, a first set of gaps 20 are expanding, while a second set of gaps 20 are contracting. Since some of the gaps 20 are expanding while others are contracting, the overall damping constant of the damper 30 has less variation around the center position. The non-linearity dependency on gap width that is inherent with conventional squeeze-film dampers is therefore overcome. Although not illustrated in FIGS. 2A, 2B and 2C, a flexible seal may be provided at either end of the damper 30 to contain the viscous fluid

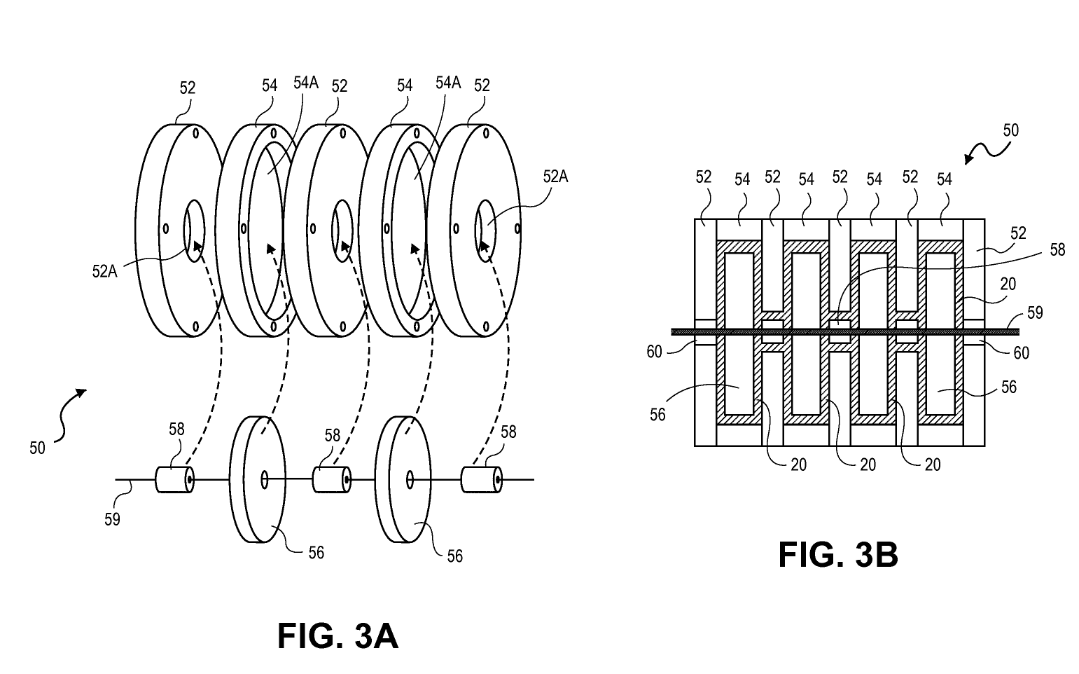

Referring to FIG. 3A, an exploded view of the individual components of a damper 50 in accordance with another embodiment is illustrated. With this embodiment, a plurality of first damping elements 52 is provided, each a circular plate having a relatively small circular recess 52A formed therein. A first set of spacer elements 54, each having a relatively large recess region 54A formed therein, is provided between each of the first damping elements 52. A plurality of second damping elements 56, each separated by a second set of spacer elements 58, is also provided. When assembled, the plurality of second damping elements 56 nest within the recess 54A of the spacers 54, while each of the second set of spacer elements 58 nest within the recess regions 52A of first damping elements 52. A shaft 59 passes through the second damping elements 56 and the second set of spacer elements 58, holding the individual components of the damper 50 together.

Referring to FIG. 3B, a cross section of the damper 50 is shown after assembly. As illustrated, gaps 20 are provided between each first and second damping element pair 52, 56. The gaps 20 are filled with a viscous fluid, resulting in a plurality of fluidic squeeze-film dampers acting in parallel. Flexible seals 60 are provided at both ends of the shaft 59 to keep the viscous fluid within the damper 50.

Like the previous embodiments, the overall damping effect of the damper 50 results from summing the damping effect of the individual fluidic squeeze-film dampers. By moving the shaft 59 back and forth, the differential motion of the elements 52, 56 causes the width of the gaps 20 to vary. Again, like the previous embodiments, a first set of gaps 20 are expanding, while a second set of gaps 20 are contracting. Since some of the gaps 20 are expanding while others are contracting, the overall damping constant of the damper 50 has less variation around the center position. The non-linearity dependency on gap width that is inherent with conventional squeeze-film dampers is therefore overcome.

With each of the embodiments 10, 30 and 50 as described above, the minimum gap 20 is determined by the required stroke. As a general rule, the smaller the width of the gaps 20, the greater the damping effect.

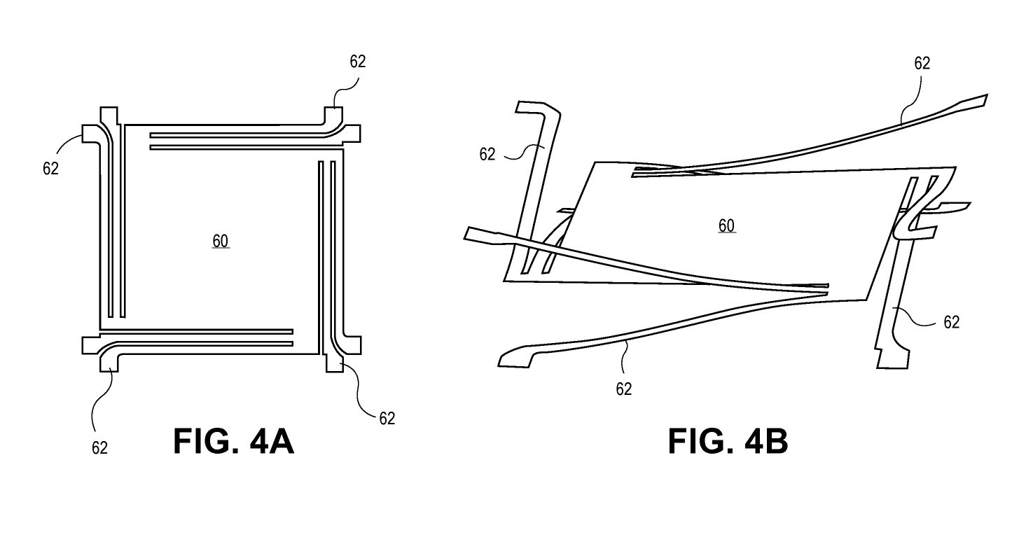

Referring to FIGS. 4A and 4B, diagrams of an intermediate damper plate 60 according to another embodiment of the invention are shown. With this embodiment, a damper plate 60 is inserted into the gaps 20 of any of the dampers 10, 30 or 50. A plurality of centering springs 62 are used to position the damper plate 60 approximately in the center of each gap 20.

The damper plates 60 are used to increase damping of the individual fluidic squeeze-film dampers. The amount of damping for a given stroke is approximated by the equation [1/(g-w³)], where g-w is the width of the gap 20. By adding the damper plate 60, the width of gap 20 is effectively reduced by a factor of two (2). As a result, the damping for each fluidic squeeze-film damper increases by a factor of four (4) based on the calculation of (2³/2=4). By including the damper plates in some or all of the gaps 20 in the dampers 10, 30, or 40, the overall damping effect can be significantly increased.

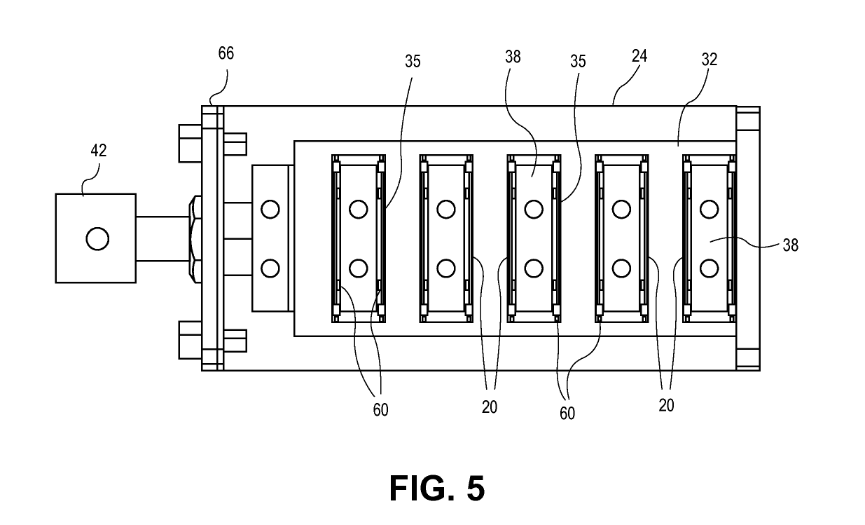

FIG. 5 is a cross section diagram of the intermediate damper plates 60 in use. This diagram shows a cross section of the damper 30, with gaps 20 provided between each damping element pair 35, 38. A damper plate 60 is provided in each of the gaps 20. As noted above, the damping of the individual fluidic squeeze-film dampers is effectively increased by a factor of four (4) with the addition of the damper plates 60.

The diagram of FIG. 5 also illustrates an optional flexible seal 66 provided between the damper 30 and an attachment element 42. The flexible seal 66 contains the viscous fluid 22 in the housing 24, while allowing motion of the damper 30 relative to the housing 24. In various embodiments, the flexible seal may be a flexible seal, a convoluted diaphragm, or a sliding seal O-ring.

It should be noted that although the damper plate 60 and the flexible seal 66 features are described and illustrated in use with the damper 30, these features can also be used with the dampers 10 and 50 as described herein. The diagram of FIG. 5 should therefore not be construed as limiting in anyway.

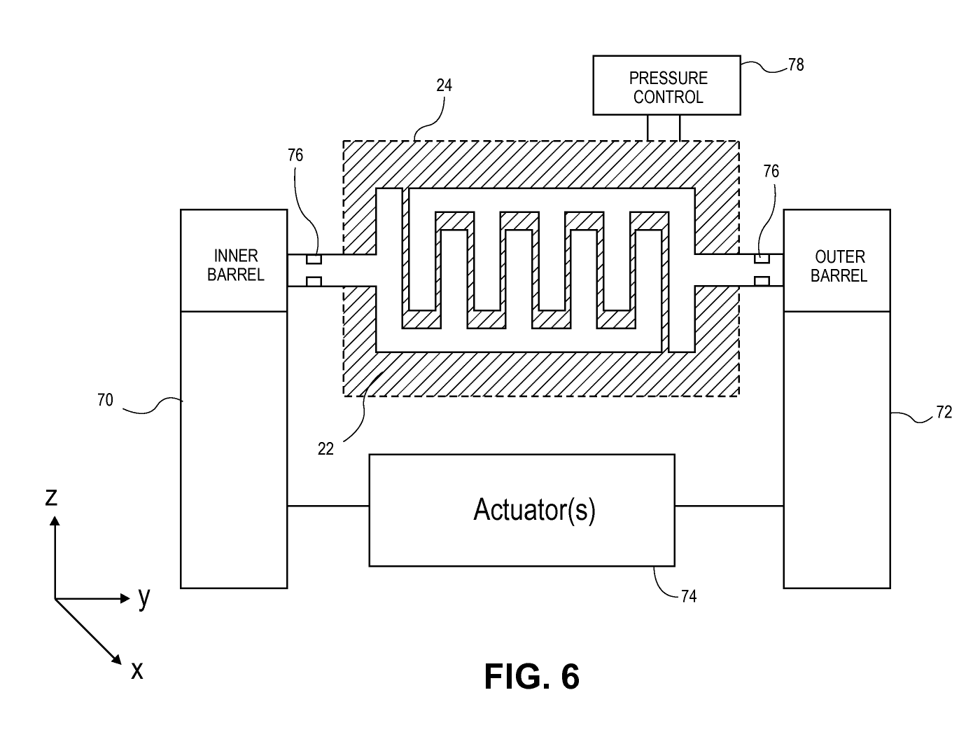

Referring to FIG. 6, a diagram illustrating the damper 10 between the inner wall 70 and outer wall 72 of a lens barrel is shown. The damper 10 is connected in parallel with one or more actuators 74. In another optional embodiment, hinges 76 are provided between the damper 10 and the inner and outer barrel walls 70 and 72. The hinges allow the damper 10 to move in the Z-direction relative to the inner and outer barrel walls 70 and 72. In addition, a pressure control element 78 is coupled to the housing 24. The pressure control element 78 maintains a negative pressure within the housing 24 to prevent the viscous fluid 22 from escaping in the event of a leak or other breach in the housing 24. Again, although the damper 10 is shown in this figure, it should be understood that the other dampers 30 and 50 could also be used in the same configuration as illustrated herein.

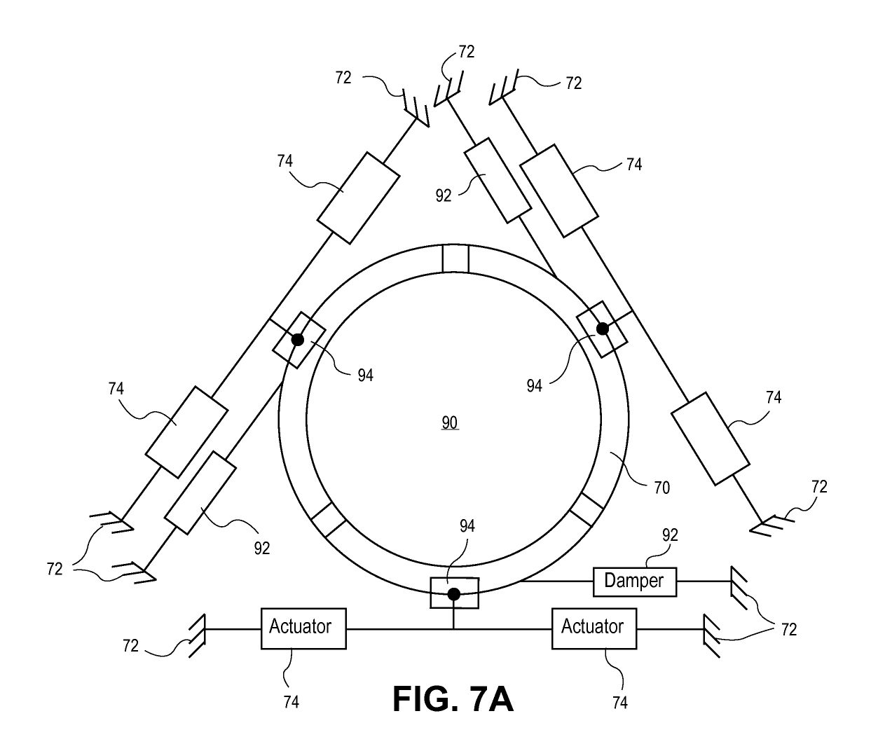

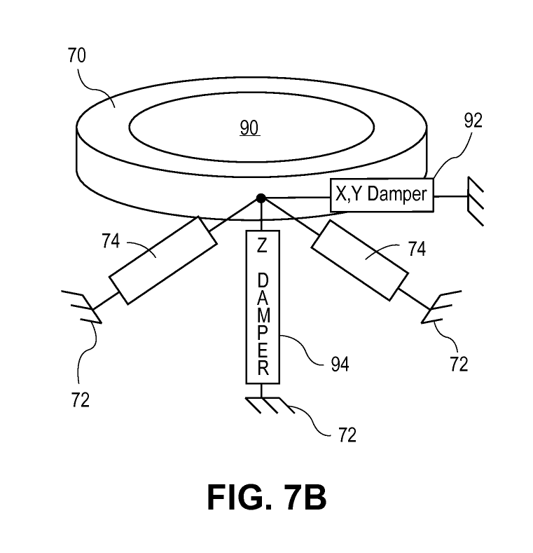

Referring to FIG. 7A, a top down view of a lens mounted within a lens barrel using several dampers of the present invention is shown. In this arrangement, a lens 90 is mounted to the inner lens barrel 70. A pair of actuators 74 is mounted in the X-Y direction between the inner lens barrel 70 and the outer lens barrel 72 at three points, each 120 degrees apart. A damper 92 also provided in the X-Y direction between the inner and out lens barrels 70 and 72. A damper 94 may also optionally be provided in the Z direction as well. The dampers 92 and 94 may optionally be any of the dampers 10, 30, or 50 as described herein, or any combination thereof.

Referring to FIG. 7B, a side view of the lens 90 mounted within the lens barrel is shown. In this view, the actuators 74 and the damper 92 are both shown positioned in the X-Y direction. The damper 94 is provided in the Z direction. For the sake of simplicity, only one set of the actuators 74 and dampers 92, 94 are shown at a single contact point. In actual implementations, a similar set of actuators and dampers would be provided at contact points 120 degrees in either direction.

The dampers 92, 94 provided in the lens barrel improves the dynamic stiffness of the connection between the inner lens barrel 70 and the outer lens barrel 72 provided by the actuators 74, particularly at high frequencies. In addition, the dampers 92, 94 reduce or eliminate at least some of the resonant mode(s), which can substantially reduce positioning errors of the lens.

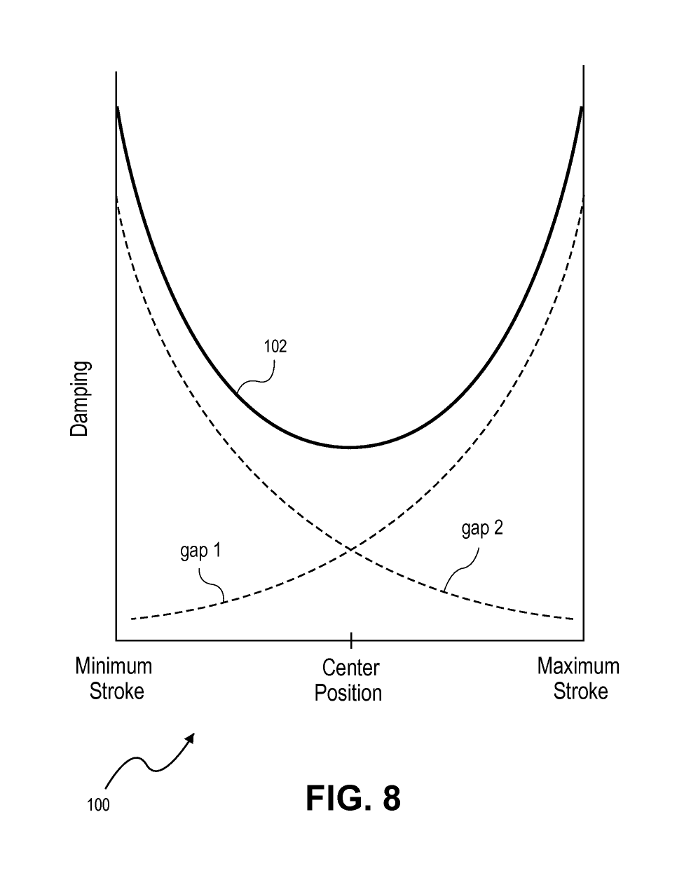

FIG. 8 is a plot illustrating damping versus stroke for adjacent pairs of the fluidic squeeze-film dampers as described above. In the plot 100, damping is provided on the vertical axis. Stroke is provided along the horizontal axis. When the width of a gap 20 approaches the minimum stroke, the amount of damping will be minimal. On the other hand when the width of a gap approaches the maximum stroke, the amount of damping is at the maximum (i.e., approaches infinity).

The stroke for adjacent gaps 20 is always the inverse of one another. For example, if a first gap (labeled “gap 1” in the diagram) is at the minimum stroke, then the adjacent gap (labeled “gap 2) will be at the maximum stroke, and vice versa. When the width of the adjacent gaps is about the same, meaning the stroke is approximately at the center point, the amount of damping of the two fluidic squeeze-film dampers will be substantially the same. Thus the curve 102 in the plot 100 represents the summed damping effect of the side-by side pair of fluidic squeeze-film dampers at any point between the maximum and minimum stroke.

The dampers as described herein, regardless of the embodiment, provide numerous advantages. The various dampers 10, 30 and 50 each achieves (i) very high damping and stiffness over a relatively short stroke, (ii) compact size and (iii) adjustability to a limited degree by adjusting the gaps. Each of these advantages makes the dampers 10, 30 and/or 50 ideally suited for use in a lens barrel of a lithography tool, where these benefits are desirable.

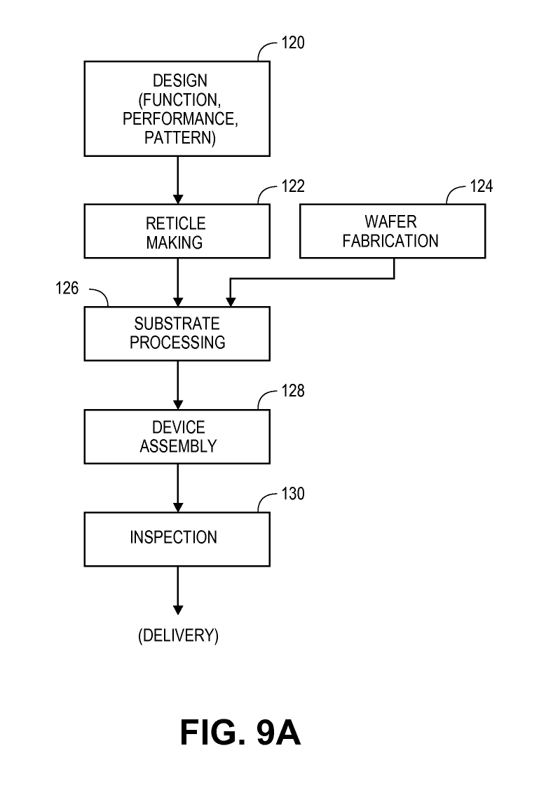

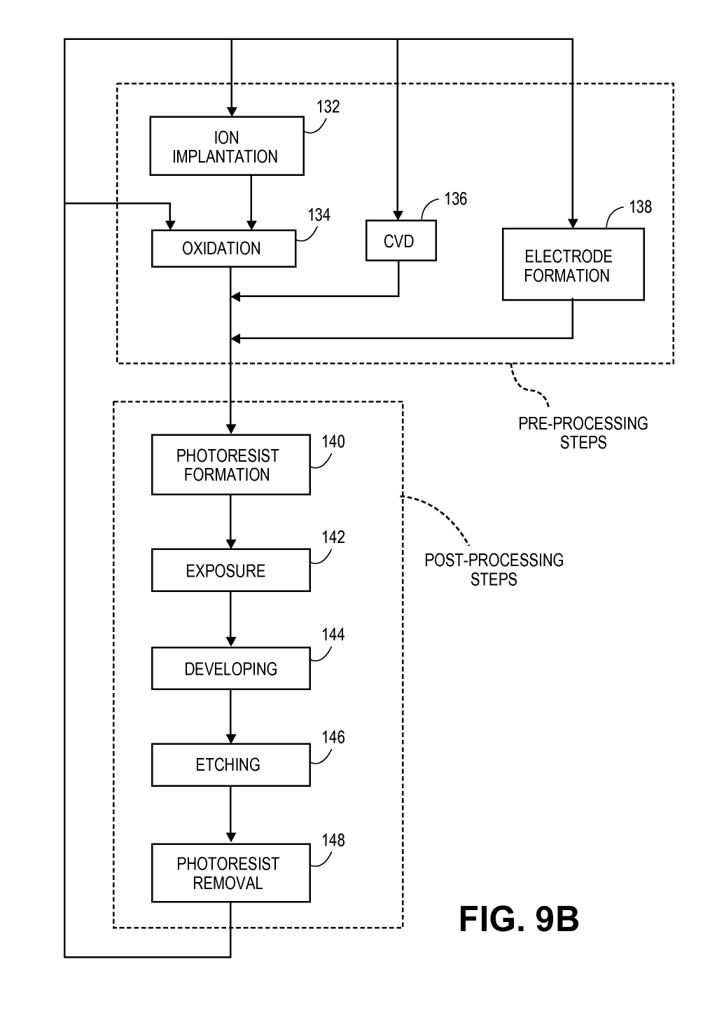

Devices, such as semiconductor die on a wafer or LCD panels, are fabricated by the process shown generally in FIG. 9A. In step 120 the function and performance characteristics of the device are designed. In the next step 122, one or more reticles, each defining a pattern, are developed according with the previous step. In a related step 124 a “blank” substrate, such as a semiconductor wafer or glass panel, is made and prepared for processing. The substrate is then processed in step 126 at least partially using the photolithography system with dampers 10, 30 and/or 50 as described herein. In step 128, the device is assembled and then inspected in step 130.

FIG. 9B illustrates a detailed flowchart example of the above-mentioned step 126 in the case of fabricating semiconductor devices. In step 132 (ion implantation step), ions are implanted in the wafer. In step 134 (oxidation step), the substrate wafer surface is oxidized. In step 136 (CVD step), an insulation film is formed on the wafer surface. In step 138 (electrode formation step), electrodes are formed on the wafer by vapor deposition. The above-mentioned steps 132-138 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 140 (photoresist formation step), photoresist is applied to a wafer. Next, in step 142 (exposure step), a lithography tool as described herein is used to transfer the pattern of the reticle to the wafer. Then in step 144 (developing step), the exposed wafer is developed, and in step 146 (etching step), parts other than residual photoresist (exposed material surface) are removed by etching. In step 148 (photoresist removal step), unnecessary photoresist remaining after etching is removed. Multiple circuit patterns are formed by repetition of these preprocessing and post-processing steps. Although not described herein, the fabrication of LCD panels from glass substrates is performed in a similar manner.

Although many of the components and processes are described above in the singular for convenience, it will be appreciated by one of skill in the art that multiple components and repeated processes can also be used to practice the techniques of the system and method described herein. Further, while the invention has been particularly shown and described with reference to specific embodiments thereof, it will be understood by those skilled in the art that changes in the form and details of the disclosed embodiments may be made without departing from the spirit or scope of the invention. For example, embodiments of the invention may be employed with a variety of components and should not be restricted to the ones mentioned above. It is therefore intended that the invention be interpreted to include all variations and equivalents that fall within the true spirit and scope of the invention.

1. An apparatus, comprising:
a damper, the damper including a plurality of fluidic squeeze-film dampers acting in parallel.

2. The apparatus of claim 1, wherein each of the plurality of fluidic squeeze-film dampers comprises:
a first damping element;
a second damping element;
a gap provided between the first damping element and the second damping element; and
a viscous fluid provided in the gap between the first damping element and the second damping element.

3. The apparatus of claim 2, wherein the viscous fluid provided in the gaps between the first damping element and the second damping element of each of the plurality of fluidic squeeze-film dampers act in parallel.

4. The apparatus of claim 2, wherein each of the plurality of fluidic squeeze-film dampers creates an individual damping effect when the viscous fluid is squeezed in the gap between the first damping element and the second damping element.

5. The apparatus of claim 2, wherein the first damping element and the second damping element are configured to move relative to one another so that the width of the gaps filled with the viscous fluid varies.

6. The apparatus of claim 4, wherein the damper has an overall damping effect that results from summing the individual damping effects created by each of the plurality of fluidic squeeze-film dampers.

7. The apparatus of claim 2, wherein each of the plurality of fluidic squeeze-film dampers further comprises a plate provided in the gap between the first damping element and the second damping element.

8. The apparatus of claim 7, wherein the plate includes one or more centering elements for centering the plate within the gap.

9. The apparatus of claim 1, wherein the damper further comprises a container to contain a viscous fluid and the plurality of fluidic squeeze-film dampers acting in parallel within the container.

10. The apparatus of claim 9, wherein the damper further comprises a pressure control element, coupled to the container, the pressure control element configured to maintain a negative pressure within the container.

11. The apparatus of claim 1, wherein the plurality of fluidic squeeze-film dampers acting in parallel further comprise:
a first elongated damping member having a first plurality of damping elements;
a second elongated damping member having a second plurality of damping elements,
the first and the second elongated damping members positioned so that the first plurality of damping elements and the second plurality of damping elements are interleaved with respect to one another and creating a gap between each interleaved pair; and
a viscous fluid provided in the gap between each interleaved pair.

12. The apparatus of claim 1, wherein the plurality of fluidic squeeze-film dampers acting in parallel further comprise:
a first elongated damping member having a plurality of recess regions;
a second elongated damping member having a plurality of damping elements positioned within the plurality of recess regions of the first elongated damping member;
gaps provided on either side of the plurality of damping elements positioned within the plurality of recess regions; and
a viscous fluid provided in the gaps provided on either side of the plurality of damping elements positioned within the plurality of recess regions.

13. The apparatus of claim 1, wherein the plurality of fluidic squeeze-film dampers acting in parallel further comprise:
a first plurality of damping elements, each of the first plurality of damping elements consisting of first circular plates;
a set of spacers separating each of the first plurality of damping elements, each of the set of spacers having a recess region;
a second plurality of damping elements, each of the second plurality of damping elements consisting of second circular plates, each nesting within the recess regions of the set of spacers respectively; and
a plurality of gaps, each filled with viscous fluid, between each of the first plurality of damping elements and the second plurality of damping elements nesting within the set of spacers separating each of the first plurality of damping elements respectively.

14. The apparatus of claim 2, wherein the viscous fluid consists of: glycerin, oil, alcohol, or grease.

15. The apparatus of claim 1, wherein the damper further comprises:
a first attachment element; and
a second attachment element, the first attachment element and the second attachment element provided on opposing ends of the damper.

16. The apparatus of claim 15, further comprising:
a lens barrel having an inner wall and an outer wall, the damper attached within the lens barrel by the first attachment element attached to the inner wall and the second attachment element attached to the outer wall.

17. The apparatus of claim 16, further comprising first and second hinges coupled between the first attachment element and the second attachment element and the inner wall and the outer wall respectively.

18. The apparatus of claim 1, wherein the damper is positioned within a lens barrel of a lithography tool, wherein the damper is configured to dampen in one of the following directions in the lens barrel:
(i) in the X direction;
(ii) in the Y direction; or
(iii) in the Z direction.

19. The apparatus of claim 18, further comprising:
a lens provided within the lens barrel;
one or more actuators for positioning the lens within the lens barrel.

20. The apparatus of claim 19, wherein the one or more actuators position the lens in up to six degrees of freedom within the lens barrel.

21. The apparatus of claim 1, further comprising:
a housing for housing the damper including a plurality of fluidic squeeze-film dampers acting in parallel;
an attachment element; and
a flexible seal between the housing and the attachment element, the flexible seal allowing the damper to move relative to the housing.
